(19) United States
(12) Patent Application Publication
(10) Pub. No.: US 2021/0009794 A1
(43) Pub. Date: Jan. 14, 2021

(54) RESIN COMPOSITION FOR SEALANT, MULTILAYER FILM FOR SEALANT, HEAT-FUSIBLE LAMINATED FILM, AND PACKAGE

(71) Applicant: PRIME POLYMER CO., LTD., Tokyo (JP)

(72) Inventors: Keiko SEKIYA, Chiba-shi, Chiba (JP); Masao SUZUKI, Chiba-shi, Chiba (JP); Tetsuya SAITO, Kisarazu-shi (JP); Yuta KUDO, Ichihara-shi, Chiba (JP)

(73) Assignee: PRIME POLYMER CO., LTD., Tokyo (JP)

(21) Appl. No.: 16/969,687

(22) PCT Filed: Mar. 7, 2019
(86) PCT No.: PCT/JP2019/009106

§ 371 Date: Aug. 13, 2020

(30) Foreign Application Priority Data
Mar. 9, 2018 (JP) 2018-042873
Mar. 9, 2018 (JP) 2018-042874

(51) Int. Cl. C08L 23/08; B32B 27/32; C08L 23/06

(52) U.S. Cl. CPC C08L 23/0815; B32B 27/32; C08L 23/06; C08L 2203/162; B32B 2439/70; C08L 2207/066; C08L 2314/02; B32B 2307/31; C08L 2205/025

(57) ABSTRACT

An object of the present invention is to provide a resin composition for a sealant combining bag manufacturing performance and inflation film process-ability (extrusion properties, bubble stability), a sealant film and a heat-fusible film produced using the composition, and a package produced using the heat-fusible film. The ethylene-based resin composition for a sealant according to the present invention satisfies the following requirements (1) to (3) simultaneously: (1) a melt index (I₂₁: 190° C., 21.6 kg load) is 42 to 80 g/10 min; (2) a ratio I₂₁/I₂ of the melt index (I₂₁: 190° C., 21.6 kg load) to a melt index (I₂: 190° C., 2.16 kg load) is 5 to 25; (3) a melt tension (190° C.) is 25 to 180 mN.

### TECHNICAL FIELD

The present invention relates to a resin composition for a sealant, a multilayer film for a sealant, a heat-fusible laminated film, and a package produced using the heat-fusible laminated film.

### BACKGROUND ART

A film made of polyethylene has been used as packaging bags for food, confectionary, snack, drug, etc., and packaging materials used as a standing pouch, tube, etc., and is required to have heat-sealing properties according to the application.

The above film made of polyethylene is formed by extruding a resin composition and conducting or not conducting stretching of the composition. Representatively, the film is manufactured by the inflation method and T-die method (also referred to as the casting method). In the inflation method, a molten resin which has been extruded in a cylindrical shape is inflated to form a thin film of cylindrical shape by blowing air into the resin, and the cylindrical product is cut to obtain a film. Since forming of a thin film reduces the strength of the film, a raw material for a film which suppress the reduction of strength is required.

As such a raw material for a film, for example, Patent literature 1 discloses a polyethylene resin composition obtained by adding high-density polyethylene and a specific high-pressure low-density polyethylene to ethylene-α-olefin copolymer wherein the resin composition has good extrusion processability and enables forming of a film having excellent easy open, tear strength and also transparency. Patent literature 2 proposes a blend of a specific ethylene-α-olefin copolymer and a specific ethylene-based polymer. Patent literature 3 discloses an easy tearable film composed of a composition comprising an ethylene-α-olefin copolymer manufactured using a metallocene catalyst and high-pressure low-density polyethylene.

### CITATION LIST

### Patent Literature

Patent Literature 1: Japanese Laid-Open Patent Publication No. 2015-93964
Patent Literature 2: WO2013/099927
Patent Literature 3: Japanese Laid-Open Patent Publication No. 2001-64456

### SUMMARY OF INVENTION

### Technical Problem

In an ethylene-based resin for a sealant in a conventional inflation film for packaging, when the molecular weight distribution of the resin is wide, the resin would have a good flowability but tend to have a lower bag-breaking strength in the case of being made into a bag and thus lower bag manufacturing performance (narrower temperature range in which bag manufacturing is possible). On the other hand, when the molecular weight distribution of the resin is narrow, the resin would have a poorer flowability and a lower melt tension, and thus tend to have lower process-ability (extrusion properties, bubble stability). Therefore, in a conventional ethylene-based resin for a sealant, the problem of difficulty in achievement of both bag manufacturing performance and process-ability (extrusion properties, bubble stability) was found. Particularly in recent years, the bag manufacturing performance is required to be enhanced in order to enable high-speed packaging of objects to be packaged (contents).

Accordingly, an object of the present invention is to provide a resin composition for a sealant combining bag manufacturing performance and process-ability (extrusion properties, bubble stability), a sealant film and a heat-fusible film produced using the composition, and a package produced using the heat-fusible film.

### Solution to Problem

The present inventors engaged in diligent study to solve the above problem, and consequently completed the present invention by discovering that both bag manufacturing performance and process-ability (extrusion properties, bubble stability) can be achieved by using a resin having a specific molecular weight distribution and melt tension. Specifically, the present invention comprises the following aspects.

[1] An ethylene-based resin composition for a sealant, satisfying the following requirements (1) to (3) simultaneously:
(1) a melt index (I₂₁: 190° C., 21.6 kg load) is 42 to 80 g/10 min;
(2) a ratio I₂₁/I₂ of the melt index (I₂₁: 190° C., 21.6 kg load) to a melt index (I₂: 190° C., 2.16 kg load) is 5 to 25;
(3) a melt tension (190° C.) is 25 to 180 mN.

[2] The ethylene-based resin composition for a sealant according to [1], comprising (A) 99.9 to 55 mass % of a linear polyethylene-based resin having a melt index (I₂: 190° C., 2.16 kg load) in the range of 0.5 to 30 g/10 min and a density in the range of 880 to 970 kg/m³, and (B) 0.1 to 45 mass % of a branched polyethylene-based resin having a melt index (I₂: 190° C., 2.16 kg load) in the range of 0.01 to 20 g/10 min and a density in the range of 900 to 940 kg/m³ (wherein the sum of the component (A) and the component (B) is 100 mass %).

[3] A sealant film comprising a layer composed of the ethylene-based resin composition for a sealant according to [1] or [2].

[4] A heat-fusible laminated film comprising the sealant film according to [3] and a substrate.

[5] A package produced using the heat-fusible laminated film according to [4].

### Advantageous Effect of Invention

According to the present invention, the ethylene-based resin composition for a sealant having excellent bag manufacturing performance and process-ability (extrusion properties, bubble stability) can be obtained. Furthermore, when a heat-fusible laminated film comprising a sealant film composed of such ethylene-based resin composition for a sealant is used, the heat-fusible laminated film has wide temperature range in which bag manufacturing is possible (high bag-breaking strength), which enables high-speed packaging of objects to be packaged (contents), and thus producibility of a package is enhanced.

### DESCRIPTION OF EMBODIMENT

Hereinafter, the present invention will be described in detail.

[Resin Composition for Sealant]

The ethylene-based resin composition for a sealant according to the present invention (hereinafter, also simply referred to as “the composition of the present invention”), is characterized by satisfying the following requirements (1) to (3) simultaneously:
(1) a melt index (1₂₁: 190° C., 21.6 kg load) is 42 to 80 g/10 min;
(2) a ratio I₂₁/I₂ of the melt index (I₂₁: 190° C., 21.6 kg load) to a melt index (I₂: 190° C., 2.16 kg load) is 5 to 25;
(3) a melt tension (190° C.) is 25 to 180 mN.

<Requirement (1)>

The melt index (I₂₁: 190° C., 21.6 kg load) of the composition of the present invention is usually 42 to 80 g/10 min, preferably 42 to 70 g/10 min, more preferably 43 to 65 g/10 min, and further preferably 45 to 63 g/10 min. When the melt index (I₂₁) is within the above range, good extrudability can be obtained. A melt index I₂₁ is a value obtained by the measurement at 190° C. and 21.6 kg load in accordance with JIS K7210.

<Requirement (2)>

The ratio I₂₁/I₂ of the melt index (I₂₁: 190° C., 21.6 kg load) to the melt index (I₂: 190° C., 2.16 kg load) of the composition of the present invention is usually 5 to 25, preferably 8 to 24, more preferably 11 to 23, and further preferably 14 to 22. When the I₂₁/I₂ is within the above range, good extrudability and bag-breaking strength are obtained. A melt index I₂ is a value obtained by the measurement at 190° C. and 2.16 kg load in accordance with JIS K7210.

<Requirement (3)>

The melt tension (190° C.) (hereinafter, also referred to as “MT”) of the composition of the present invention is usually 25 to 180 mN, preferably 30 to 160 mN, more preferably 35 to 140 mN, further preferably 40 to 115, and particularly preferably 45 to 90. When the MT is within the above range, process-ability is good in terms of bubble stability, the suppression of melt fracture, etc. MT was measured by the method described below using a strand produced by melt extrusion at 190° C.

The composition of the present invention which satisfies the above requirements (1) to (3) preferably comprises
(A) 99.9 to 55 mass % of a linear polyethylene-based resin (hereinafter, also referred to as “ethylene-based resin (A)” or “component (A)”) having a melt index (I₂: 190° C., 2.16 kg load) in the range of 0.5 to 30 g/10 min and a density in the range of 880 to 970 kg/m³, and
(B) 0.1 to 45 mass % of a branched polyethylene-based resin (hereinafter, also referred to as “ethylene-based resin (B)” or “component (B)”) having a melt index (1₂: 190° C., 2.16 kg load) in the range of 0.01 to 20 g/10 min and a density in the range of 900 to 940 kg/m³
(wherein the sum of the component (A) and the component (B) is 100 mass %).

<Ethylene-Based Resin (A)>

The I₂ of the component (A) is usually in the range of 0.5 to 30 g/10 min, preferably 1.0 to 25 g/10 min, more preferably 1.5 to 20 g/10 min, and further preferably 2.0 to 12 g/10 min.

The density of the component (A) is usually in the range of 880 to 970 kg/m³, preferably 885 to 950 kg/m³, more preferably 890 to 945 kg/m³, and further preferably 895 to 940 kg/m³. The above density is a value obtained by the measurement in accordance with JIS K7112 (density gradient tube method).

As the component (A), for example, a linear low-density polyethylene, etc. can be exemplified. The linear low-density polyethylene comprises a copolymer of ethylene and α-olefin, and such copolymer can be obtained using a known catalyst such as Ziegler-Natta catalyst and metallocene catalyst. In the present invention, the linear polyethylene-based resin satisfying the above-mentioned properties can be selected from commercially available linear polyethylene-based resins and can be used. As the component (A), two or more linear polyethylene-based resins can be used.

The ratio of the component (A) mixed in the composition of the present invention is usually in the range of 99.9 to 55 mass %, preferably 99 to 60 mass %, more preferably 98.5 to 65 mass %, and further preferably 98 to 70 mass % (wherein the sum of the component (A) and the component (B) is 100 mass %). When the ratio of the component (A) mixed in the composition is within the above range, good low-temperature sealability is obtained.

<Ethylene-Based Resin (B)>

The I₂ of the component (B) is usually in the range of 0.01 to 20 g/10 min, preferably 0.05 to 17 g/10 min, more preferably 0.08 to 15 g/10 min, and more preferably 0.1 to 10 g/10 min.

The density of the component (B) is usually in the range of 900 to 940 kg/m³, preferably 905 to 935 kg/m³, more preferably 908 to 932 kg/m³, and further preferably 910 to 930 kg/m³.

As long as the component (B) is a branched polyethylene-based resin satisfying the above physical properties, the component (B) may be a so-called high-pressure low-density polyethylene manufactured using a radical catalyst under a high pressure, or a so-called middle/low-pressure polyethylene manufactured using a Ziegler-Natta catalyst or a metallocene catalyst in the presence of ethylene and a comonomer such as α-olefin under middle/low pressure. A high-pressure low-density polyethylene can be preferably used in the present invention since it has long chain branching present in the molecular chain and thus exhibits a high melt tension. In the present invention, the branched polyethylene-based resin satisfying the above-mentioned properties can be selected from commercially available branched polyethylene-based resins and can be used.

The ratio of the component (B) mixed in the composition of the present invention is usually in the range of 0.1 to 45 mass %, preferably 1 to 40 mass %, more preferably 1.5 to 35 mass %, and further preferably 2 to 30 mass % (wherein the sum of the component (A) and the component (B) is 100 mass %). When the ratio of the component (B) mixed in the composition is within the above range, good low-temperature sealability is obtained.

<Other Components>

The composition of the present invention may contain, if needed, various additives such as a weathering stabilizer, heat-resistant stabilizer, antistatic agent, antifogging agent, anti-blocking agent, slipping agent, lubricant, pigment and antisticking agent which are commonly added to polyolefin, in an amount within a range not inhibiting achievement of the purpose of the present invention.

[Sealant Film]

The sealant film of the present invention is characterized in that it comprises a layer composed of the above-mentioned composition of the present invention. The sealant film of the present invention may be a laminated film further comprising a layer composed of other material, as long as it does not inhibit the effect of the present invention.

In the above laminated film, at least one of surface layers is preferably a layer composed of the composition of the present invention. In this laminated film, the layer composed of the composition of the present invention may be formed on only one side, or may be formed on both sides. The substrate constituting this laminated film may be a substrate composed of the composition of the present invention or a substrate composed of other material. When a layer of other material is laminated, the layer composed of the composition of the present invention preferably has a thickness which is ⅕ or more of the thickness of the whole film, further preferably ¼ or more, and most preferably ⅓ or more.

The thickness of the sealant film of the present invention may be appropriately determined depending on various applications, and the thickness of the layer composed of the ethylene-based resin composition is usually in the range of 5 to 250 μm, preferably 10 to 200 μm.

<Manufacturing Method of Sealant Film>

A manufacturing method of the sealant film of the present invention is not particularly limited, and film formation can be conducted by a known melt extrusion forming method. As a melt extrusion forming method, a known method can be adopted without any limitation, but film formation is preferably conducted by inflation forming. The thus obtained film may be used as it is as a non-stretched film or may be further stretched and used as a stretched film to be processed into a film for manufacturing of a bag for food packaging. In this case, the thickness of the film obtained by melt extrusion forming (referred to as an original film to be stretched, and includes a thick formed product which is referred to as a sheet depending on the thickness) varies depending on the forming method. An original film to be stretched preferably has a thickness of 50 μm to 2000 μm, and more preferably 100 μm to 1500 μm, in the case of being produced by inflation forming. A cooling method of a molten resin may be air cooling or water cooling. In the case of a laminated film in which a layer of other material is laminated, a multilayer original film to be stretched which is obtained by coextrusion forming using a multilayer die may be used.

Methods of stretching an original film include, for example, a method of biaxial stretching in the longitudinal and width directions simultaneously or sequentially by tenter method, a method of biaxial stretching in the longitudinal and width directions simultaneously by tubular method, or a method of uniaxial stretching in a flow direction of the film by utilizing a ratio of rotational speeds of two or more rolls.

[Heat-Fusible Laminated Film]

The heat-fusible laminated film of the present invention (hereinafter, also simply referred to as “the heat-fusible film of the present invention”) is characterized in that it comprises the sealant film of the present invention and a substrate.

The above-mentioned substrate is not particularly limited, and includes known thermoplastic resins, for example, polyolefins [polyethylenes such as high-pressure low-density polyethylene, linear low-density polyethylene (LLDPE: ethylene-α-olefin random copolymer), medium-density polyethylene and high-density polyethylene; polypropylenes such as propylene homopolymer and propylene-α-olefin random copolymer (propylene random copolymer); poly-4-methyl-pentene; polybutene; etc.], polyester (polyethylene terephthalate, polybutylene terephthalate, polyethylene naphthalate, etc.), polyamide (nylon-6, nylon-66, polymetaxylene adipamide, etc.), polyvinyl chloride, polyimide, ethylene-vinyl acetate copolymer or a saponified product thereof, polyvinyl alcohol, polyacrylonitrile, polycarbonate, polystyrene and ionomer, and these may be used alone or in combination of two or more. Among these, thermoplastic resins having good stretchability and transparency such as polypropylene, polyester (in particular polyethylene terephthalate) and polyamide are preferable.

The heat-fusible film of the present invention can be manufactured by a method of dry-laminating the sealant film and the substrate or by a method of coextruding resins constituting respective layers.

When the sealant film and the substrate cannot be adhered with sufficient adhesion strength, an adhesive layer can be provided between the layers. As an adhesive layer, anchor coating agents such as a urethane-based adhesive and an isocyanate-based adhesive, and adhesive resins such as a modified polyolefin, for example, a polyolefin grafted with an unsaturated carboxylic acid can be used to adhere adjacent layers together tightly.

The heat-fusible film of the present invention is suitable for various films for packaging such as a bag for water-containing product, a bag for liquid soup packaging, a paper container for liquid, original film to be laminated, a special-shaped bag for liquid packaging (such as a standing pouch), a standard bag, a heavy duty bag, a wrap film, a sugar bag, a bag for oil-containing product and food packaging; and clean films used for a protective film, an infusion solution bag, an agricultural material, a bag-in-box, and packaging of a semiconductor material, a pharmaceutical product, a food and the like.

[Package]

The package of the present invention is obtained in such a way that, for example, the heat-fusible film of the present invention is made into a bag-shaped container, the objects to be packaged (contents) for the above-mentioned various applications are packed into the container, which is then sealed by heat-sealing. The heat-fusible film of the present invention has a wide temperature range in which bag manufacturing is possible and an excellent bag-breaking strength, and thus enables high-speed packaging of contents.

### EXAMPLES

Hereinafter, the present invention will be described more specifically with reference to Examples, but the present invention is not in any way limited to these Examples.

In the Examples below, the melt index, density, melt tension and the ability of high-speed packaging were measured as follows.

<Melt Index>

The melt index I₂₁ was measured at 190° C. and 21.6 kg load in accordance with JIS K7210, the melt index I₂ was measured at 190° C. and 2.16 kg load in accordance with JIS K7210, and from these values, the melt index ratio I₂₁/I₂ was calculated.

<Density [kg/m³]>

The strand obtained in the measurement of the melt index was heat treated at 100° C. for 1 hour, left at room temperature for additional 1 hour, and then the density was measured by the density gradient tube method in accordance with JIS K7112.

<Melt Tension (190° C.) [mN]>

The MT (190° C.) at 190° C. was determined by measuring the stress when the specimen was stretched at a constant speed. A capillary rheometer: CAPILOGRAPH 1B manufactured by Toyo Seiki Seisaku-sho, Ltd. was used for the measurements. The conditions were as follows: resin temperature 190° C., melting time 6 minutes, barrel diameter 9.55 mmφ, extrusion speed 15 mm/min, winding speed 24 m/min (when the molten filament was broken, winding speed was reduced with increment of 5 m/min), nozzle diameter 2.095 mmφ, nozzle length 8 mm.

<Ability of High-Speed Packaging>

For the heat-fusible film obtained in each Example and Comparative Example, 10 bags were produced at sealing temperature of 100 to 199° C. using a vertical pillow type high-speed bag manufacturing machine (sealing time: 0.1 second). Then, submersion tests for 10 bags manufactured at each temperature were conducted, and the temperature range at which no leakage was observed was determined as the temperature range in which bag manufacturing is possible.

### Examples 1 to 6 and Comparative Examples 1 to 3

The ethylene-based resin compositions having composition shown in Table 1 were prepared, and I₂₁, I₂₁/I₂, the density and MT (190° C.) thereof were measured. The results are shown in Table 1.

The films having a thickness of 40 μm (non-stretched) were manufactured by air-cooling inflation forming of the obtained ethylene-based resin compositions using an inflation forming machine under the conditions below. The resin pressure (extrusion properties) [kg/cm²] during that process was measured, and bubble stability was visually evaluated. The results are shown in Table 1.

<Film Forming Conditions>
Forming machine: 65 mmφ inflation forming machine manufactured by Modern Machinery Co., Inc.
Die: 125 mmφ (diameter), 4.0 mm (lip width)
Forming temperature: 190° C.
Extrusion rate: 50 kg/h
Take-off speed: 20.5 m/min

<Manufacturing of Heat-Fusible Film>

The laminated film obtained by applying a urethane-based anchor coating agent to one side of a biaxially stretched PET film (“EMBLET” manufactured by UNITIKA LTD.) having a thickness of 12 μm, and then laminating a biaxially stretched nylon film (“EMBLEM” manufactured by UNITIKA LTD.) having a thickness of 15 μm thereto was used as a substrate.

A urethane-based anchor coating agent was applied to the nylon side of the obtained substrate. Then, using a 65 mmφ extruder and a laminator having a T die having die width of 500 mm manufactured by Sumitomo Heavy Industries, Ltd., polyethylene resins (ethylene-based resin “SP1071C” manufactured by Prime Polymer Co., Ltd.) was extruded and laminated between the obtained sealant film and the substrate so as to obtain the film thickness of 10 μm under conditions of an air gap of 130 mm, an under-die resin temperature of 320° C. and a take-off speed of 80 m/min, and the heat-fusible film was obtained. The obtained heat-fusible film was evaluated with regard to the ability of high-speed packaging by the above-mentioned method. The results are shown in Table 1.

TABLE 1

| | | | | Ex. 1 | Ex. 2 | Ex. 3 | Ex. 4 | Ex. 5 |
|---|---|---|---|---|---|---|---|---|
| Resin | Composition | Component | Resin (a-1) | 90 | 90 | 80 | 80 | 80 |
| composition | | (A) | Resin (a-2) | — | — | — | — | — |
| | | | Resin (a-3) | — | — | — | — | — |
| | | Component | Resin (b-1) | 10 | — | — | — | — |
| | | (B) | Resin (b-2) | — | 10 | 20 | — | — |
| | | | Resin (b-3) | — | — | — | 20 | — |
| | | | Resin (b-4) | — | — | — | — | 20 |
| | Physical | I₂₁ | [g/10 min] | 50 | 49 | 43 | 54 | 61 |
| | properties | I₂₁/I₂ | | 17 | 17 | 19 | 17 | 18 |
| | | MT (190° C.) | [mN] | 62 | 50 | 108 | 70 | 56 |
| | | Density | [kg/cm³] | 914 | 915 | 916 | 915 | 915 |
| Formability | Extrusion property | | [kg/cm²] | 140 | 153 | 173 | 155 | 154 |
| | Bubble stability | | | Stable | Stable | Stable | Stable | Stable |
| Ability of | Bag- | Horizontal | 120° C. | — | — | — | — | — |
| high-speed | breaking | sealing | 125° C. | 10/10 | — | — | — | — |
| packaging | strength | temperature | 130° C. | 3/10 | — | — | — | — |
| | | | 135° C. | — | 7/10 | 10/10 | 10/10 | 10/10 |
| | | | 140° C. | 0/10 | 2/10 | 2/10 | 4/10 | 1/10 |
| | | | 145° C. | — | 0/10 | 0/10 | 0/10 | 0/10 |
| | | | 150° C. | 0/10 | — | 0/10 | 0/10 | 0/10 |
| | | | 155° C. | — | — | — | — | — |
| | | | 160° C. | 0/10 | 0/10 | 0/10 | 0/10 | 0/10 |
| | | | 170° C. | 0/10 | — | 0/10 | 0/10 | 0/10 |
| | | | 180° C. | 0/10 | — | 0/10 | 0/10 | 0/10 |
| | | | 190° C. | 1/10 | 0/10 | 8/10 | 0/10 | 0/10 |
| | | | 199° C. | 1/10 | 0/10 *2 | 2/10 *2 | 2/10 *2 | 0/10 *2 |

| | | | | | | |
|---|---|---|---|---|---|---|
| Temperature range in which bag | [° C.] | 40 | 54 | 35 | 45 | 54 |
| manufacturing is possible | | | | | | |

| | | | | | Comp. | Comp. | Comp. |
|---|---|---|---|---|---|---|---|
| | | | | Ex. 6 | Ex. 1 | Ex. 2 | Ex. 3 |
| Resin | Composition | Component | Resin (a-1) | — | 100 | — | 70 |
| composition | | (A) | Resin (a-2) | 90 | — | — | — |
| | | | Resin (a-3) | — | — | 100 | — |
| | | Component | Resin (b-1) | 10 | — | — | — |
| | | (B) | Resin (b-2) | — | — | — | 30 |
| | | | Resin (b-3) | — | — | — | — |
| | | | Resin (b-4) | — | — | — | — |
| | Physical | I₂₁ | [g/10 min] | 48 | 61 | 53 | 36 |
| | properties | I₂₁/I₂ | | 17 | 16 | 26 | 22 |
| | | MT (190° C.) | [mN] | 70 | 6 | 71 | 166 |
| | | Density | [kg/cm³] | 914 | 913 | 916 | 917 |
| Formability | Extrusion property | | [kg/cm²] | 145 | Impossible | 134 | 188 |
| | Bubble stability | | | Stable | of | Stable | Stable |
| Ability of | Bag- | Horizontal | 120° C. | *1 | forming | *1 | — |
| high-speed | breaking | sealing | 125° C. | *1 | | *1 | — |
| packaging | strength | temperature | 130° C. | 9/10 | | *1 | — |
| | | | 135° C. | 2/10 | | 6/10 | 10/10 |
| | | | 140° C. | 0/10 | | 8/10 | 10/10 |
| | | | 145° C. | — | | — | 3/10 |
| | | | 150° C. | 0/10 | | 1/10 | 2/10 |
| | | | 155° C. | — | | — | 1/10 |
| | | | 160° C. | 0/10 | | 1/10 | 0/10 |
| | | | 170° C. | 0/10 | | 1/10 | 0/10 |
| | | | 180° C. | 0/10 | | 1/10 | 0/10 |
| | | | 190° C. | 0/10 | | 3/10 | 0/10 |
| | | | 199° C. | 0/10 | | 4/10 | 0/10 *2 |

| | | | | |
|---|---|---|---|---|
| Temperature range in which bag | [° C.] | 59 | 0 | 39 |
| manufacturing is possible | | | | |

The details of the resin (a-1) to (a-3), resin(b-1) to (b-4), *1 and *2 in Table 1 are as follows.

Resin (a-1): ethylene-based resin “SP1540” manufactured by Prime Polymer Co., Ltd. (I₂: 3.8 g/10 min, density: 913 kg/m³)

Resin (a-2): resin blend of 52 mass % of ethylene-based resin “SP0540” manufactured by Prime Polymer Co., Ltd. (I₂: 3.8 g/10 min, density: 904 kg/m³) and 48 mass % of ethylene-based resin “SP2540” manufactured by Prime Polymer Co., Ltd. (I₂: 3.8 g/10 min, density: 923 kg/m³)

Resin (a-3): ethylene-based resin “SP2020” manufactured by Prime Polymer Co., Ltd. (I₂: 2.3 g/10 min, density: 916 kg/m³)

Resin (b-1): high-pressure polyethylene (I₂: 0.3 g/10 min, density: 921 kg/m³)

Resin (b-2): high-pressure polyethylene (I₂: 0.2 g/10 min, density: 922 kg/m³)

Resin (b-3): high-pressure polyethylene (I₂: 2.8 g/10 min, density: 918 kg/m³)

Resin (b-4):high-pressure polyethylene (I₂: 6.5 g/10 min, density: 918 kg/m³)

*1: NG due to not being sealed

*2: Poor appearance

As shown in Table 1 above, the resin compositions of Examples 1 to 6 have excellent process-ability, and the films produced using the compositions have wide temperature range in which bag manufacturing is possible and thus provides the excellent ability of high-speed packaging.

1. An ethylene-based resin composition for a sealant, satisfying the following requirements (1) to (3) simultaneously:
(1) a melt index (I₂₁: 190° C., 21.6 kg load) is 42 to 80 g/10 min;
(2) a ratio I₂₁/I₂ of the melt index (I₂₁: 190° C., 21.6 kg load) to a melt index (I₂: 190° C., 2.16 kg load) is 5 to 25;
(3) a melt tension (190° C.) is 25 to 180 mN.

2. The ethylene-based resin composition for a sealant according to claim 1, comprising
(A) 99.9 to 55 mass % of a linear polyethylene-based resin having a melt index (I₂: 190° C., 2.16 kg load) in the range of 0.5 to 30 g/10 min and a density in the range of 880 to 970 kg/m³, and
(B) 0.1 to 45 mass % of a branched polyethylene-based resin having a melt index (I₂: 190° C., 2.16 kg load) in the range of 0.01 to 20 g/10 min and a density in the range of 900 to 940 kg/m³
(wherein the sum of the component (A) and the component (B) is 100 mass %).

3. A sealant film comprising a layer composed of the ethylene-based resin composition for a sealant according to claim 1.

4. A heat-fusible laminated film comprising the sealant film according to claim 3 and a substrate.

5. A package produced using the heat-fusible laminated film according to claim 4.
